(19) United States
(12) Patent Application Publication
(10) Pub. No.: US 2026/0168307 A1
(43) Pub. Date: Jun. 18, 2026

(54) DRIVE, IN PARTICULAR SPINDLE DRIVE

(71) Applicant: Brose Fahrzeugteile SE & Co. Kommanditgesellschaft, Bamberg, Bamberg (DE)

(72) Inventors: Marco SCHRAMM, Seßlach (DE); Florian WOHLLEBER, Trailsdorf (DE); Frank HÄLBIG, Bamberg (DE); Matthias FISCHER, Itzgrund (DE); Lucas LANG, Nürnberg (DE); Patrick ZEUß, Bad Rodach (DE); Maximilian KNOPF, Hollfeld (DE); Sascha KUNKEL, Würzburg (DE)

(21) Appl. No.: 19/423,572

(22) Filed: Dec. 17, 2025

(30) Foreign Application Priority Data
Dec. 17, 2024 (DE) 202024002509.8
Apr. 25, 2025 (DE) 102025116042.2

(51) Int. Cl. E05F 15/622

(52) U.S. Cl. CPC E05F 15/622; E05Y 2201/434; E05Y 2201/628; E05Y 2201/702; E05Y 2201/72; E05Y 2900/546

(57) ABSTRACT

A drive for adjusting an adjustable element of a motor vehicle, the drive having a drive train with two drive portions, which can be adjusted relative to one another along a geometric drive axis between a retracted position and an extended position and which comprise a plurality of train components which are coupled to one another to transmit force or torque so as to transmit a force introduced into the drive connections, wherein the drive comprises a feed gear for carrying out in particular linear drive movements along the geometric drive axis, one of the two drive portions having a drive unit with a drive motor, downstream of which the feed gear is arranged, the drive motor having a motor shaft that has a geometric motor shaft axis and transmits a torque generated by the drive motor, and a bearing arrangement with at least one motor shaft bearing.

### CROSS-REFERENCE TO RELATED APPLICATION

This application claims priority pursuant to 35 U.S.C. 119(a) to German Patent Office Application No. 102025116042.2, filed Apr. 25, 2025, and German Application No. 202024002509.8, filed Dec. 17, 2024, of which the entire contents of these applications are incorporated herein by reference.

### TECHNICAL FIELD

The present invention relates to a drive, particularly a spindle drive, in accordance with the preamble of claim 1.

### BACKGROUND

The drive in question can be used for all possible adjustable elements of a motor vehicle. Examples include a tailgate, a trunk lid, a door, particularly a side door, a hood or the like of a motor vehicle.

German Patent No. DE 10 2020 113 958 A1 relates to a drive in the form of a spindle drive. This comprises a drive train having a plurality of train components via which torque can be transmitted. In this way, the torque in the drive train is transmitted from the motor shaft of a drive motor to an input-side feed gear component of a feed gear. The feed gear is configured here as a spindle-spindle nut gear with a spindle and a spindle nut that meshes therewith, wherein the input-side feed gear component of the feed gear is formed by the spindle. The spindle-spindle nut gear converts rotary movements into linear drive movements between two drive connections of the drive. Furthermore, a reduction gear configured as a planetary gear is interposed between the drive motor and the feed gear. The drive motor has a bearing arrangement with at least one motor shaft bearing for mounting the motor shaft.

The motor shaft is regularly mounted with radial clearance (bearing clearance) so that the motor shaft is radially movable, albeit only to a small extent, relative to the rest of the drive motor, in particular relative to the motor housing. One challenge is the tendency of the motor shaft to oscillate freely, accompanied by modulating background noise.

### SUMMARY

The problem addressed by the invention is that of designing and developing the known drive so as to optimize it in terms of the noise generated in the drive.

The above object is achieved by the features of the characterizing part of claim 1. The invention relates to a drive for adjusting an adjustable element of a motor vehicle, the drive comprising a drive train with two drive portions, which can be adjusted relative to one another along a geometric drive axis between a retracted position and an extended position and which comprise a plurality of train components which are coupled to one another to transmit force or torque so as to transmit a force introduced into the drive connections, wherein the drive comprises a feed gear for carrying out in particular linear drive movements along the geometric drive axis, one of the two drive portions having a drive unit with a drive motor, downstream of which the feed gear is arranged, the drive motor having a motor shaft that has a geometric motor shaft axis and transmits a torque generated by the drive motor, and a bearing arrangement with at least one motor shaft bearing, which comprises a geometric bearing center axis and is configured to radially support the motor shaft. It is proposed that the drive has a radial force introduction unit which radially acts on the rotating motor shaft in the assembled state so that the motor shaft rests against one side of the motor shaft bearing in a defined position.

The fundamental principle of pressing the motor shaft, which in particular has radial clearance, in the radial direction against an associated motor shaft bearing is essential in order to prevent free oscillation and to suppress corresponding modulating background noise. This is achieved by applying a targeted load to one side of the motor shaft, which clamps the motor shaft in the motor shaft bearing, or, in the case of a plurality of motor shaft bearings, in one or two of the motor shaft bearings. This ensures that the motor shaft occupies a defined position in the motor shaft bearing, which improves smooth running.

Specifically, it is proposed that the drive has a radial force introduction unit configured to act radially on the rotating motor shaft in the assembled state so that the motor shaft rests against one side of the motor shaft bearing in a defined position.

Claims 2 and 3 define a force application means that enables the targeted and controlled application of a radial force to the motor shaft and ensures that the motor shaft rests on one side of the motor shaft bearing in a define manner.

Claims 4 and 5 specify the preferred position of the radial force introduction unit and the force application means within the drive. Thus, the motor shaft is often particularly susceptible to vibration, especially on the axial side of the drive motor facing the feed gear. However, in principle, an arrangement at a different position in the drive may also be advantageous, for example for reasons of simpler assembly and maintenance, such as on the side of the drive motor facing away from the feed gear. The arrangement can be made inside or outside the motor housing.

In accordance with the particularly preferred embodiment in accordance with claim 6, the force application means that the application of radial force on or the radial deflection of the motor shaft is a preferably elastic clip, in particular made of metal and/or spring steel sheet. Such a component can be installed radially between existing train components and/or gear components, one of which is a drive part coupled to the motor shaft to transmit torque or is formed by the motor shaft itself, in a particularly simple and space-saving manner.

In accordance with claim 7, the clip can be secured against rotation by one or more outward-facing end-side edges so that the motor shaft maintains its defined position in the motor shaft bearing. To connect the clip for conjoint rotation, it is anchored by its respective edges in particular on the radial outside of one of the train components and/or gear components.

Claim 8 relates to a reduction gear arranged downstream of the drive motor, which, in accordance with claim 9, particularly preferably comprises a planetary gear. In this case, the clip is installed in particular between two gear components, one of which is the drive part coupled to the motor shaft to transmit torque. The drive part to which a radial force is applied or which is radially deflected by the force application means is preferably the sun gear of the planetary gear. Claim 10 specifies the arrangement of the clip radially between the sun gear and the ring gear of the planetary gear.

In accordance with the likewise particularly preferred embodiment in accordance with claim 11, the force application means that causes the application of radial force on or the radial deflection of the motor shaft is a preferably rigid ring-shaped additional part, in particular made of metal and/or casting material, which extends around the motor shaft. Examples include polyetheretherketone, polypropylene, polyphthalamide, or polyketone.

Claims 12 to 15 relate to further particularly preferred variants of the force application means.

Claim 16 specifies the arrangement of the ring-shaped additional part radially between the motor shaft and the motor shaft bearing or one of the motor shaft bearings radially supporting the motor shaft.

Claim 17 specifies preferred variants of the motor shaft axis course when the radial force introduction unit or the force application means are acting radially thereupon.

Claim 18 relates to a particularly preferred embodiment in which the feed gear is configured as a spindle-spindle nut gear.

In accordance with the particularly preferred embodiment in accordance with claim 19, the drive has a drive housing with a housing inner tube and a housing outer tube that radially surrounds the radial force introduction unit or the force application means in order to protect these components from the region around the drive.

### BRIEF DESCRIPTION OF THE DRAWINGS

In the following, the invention is explained in more detail with reference to a drawing that merely represents exemplary embodiments. In the drawing:

FIG. 1 is a perspective view of the rear of a motor vehicle with at least one drive as proposed, as well as a partially sectional side view of the drive in the retracted state and, quite schematically, the motor shaft of a drive motor of the drive in various load states;

FIG. 2 shows, for a first embodiment of the proposed drive, a) sectional views of an axial portion of the drive and b) exploded views of the axial portion of the drive;

FIG. 3 shows, for a second embodiment of the proposed drive, a) sectional views of an axial portion of the drive and b) exploded views of the axial portion of the drive; and,

FIG. 4 shows different variants of a ring-shaped additional part for the second embodiment of the proposed drive in accordance with FIG. 3.

### DETAILED DESCRIPTION OF THE INVENTION

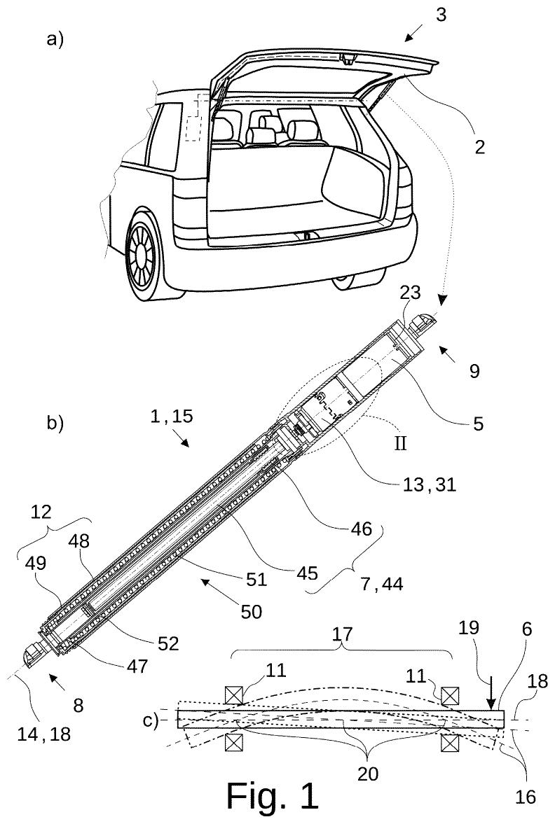

The drive 1 shown in the drawings, in this case, and preferably, a spindle drive, serves for the motor-driven adjustment of an adjustable element 2 of a motor vehicle 3, which is configured as a tailgate in accordance with FIG. 1 by way of example. This is advantageous but should not be understood as restrictive. Rather, the proposed drive 1 can be used for every adjustable element 2 possible of a motor vehicle 3, for example also for a trunk lid, a door, in particular a side door, a hood or the like of a motor vehicle 3.

FIG. 1 shows that the drive 1 has a drive train 4 comprising a plurality of train components. In this sense, train components are components that can transmit forces and/or, as in this case, torques in the drive 1 and are necessary for adjusting the adjustable element 2.

The drive train 4 comprises a drive motor 5, which has a motor shaft 6 extending in an axial direction, and a feed 7 comprising an input-side feed gear component and an output-side feed gear component for generating in particular linear drive movements between two drive connections 8, 9. A “feed gear component” is a gear component that is necessary for generating a feed motion, for example a threaded rod (“spindle”), rack-and-pinion or the like. The two drive connections 8, 9 are provided at the end of the drive 1 in FIG. 1 and serve to pass the drive movements to the motor vehicle 3, specifically the first drive connection 8 to the adjustable element 2 and the second drive connection 9 to the rest of the motor vehicle 3.

The motor shaft 6 is mounted radially and in this case also axially via at least one motor shaft bearing 11, in this case and preferably in a motor housing 10 of the drive motor 5. The motor shaft 6 is regularly mounted with radial clearance, or what is known as bearing clearance, between the motor shaft bearing 11 and the motor shaft 6 so that the motor shaft 6 is radially movable, albeit only to a small extent, relative to the rest of the drive motor 5, in particular relative to the motor housing 10.

In this context, a motor housing 10 of the drive motor 5 is to be distinguished from an optional drive housing 12 of the proposed drive 1, which will be described in more detail below and which, in addition to the drive motor 5, also at least partially radially surrounds a reduction gear 13 and/or the feed gear 7. Instead, the motor housing 10 supports and protects the electrical and mechanical components of the drive motor 5 (e.g., the stator, the rotor, the commutator, the windings or the like) but does not surround the reduction gear 13 or the feed gear 7.

The drive motor 5 with its motor shaft 6 on the one hand and the feed gear components of the feed gear 7 on the other hand each form train components of the drive train 4. A torque can be transmitted from the motor shaft 6, via further train components of the drive train 4, and to the input-side feed gear component of the feed gear 7.

The embodiment shown in the figures, which is preferred in this respect, accordingly relates to a drive 1, in particular a spindle drive, for adjusting an adjustable element 2, in particular a flap, of a motor vehicle 3, wherein the drive 1 has a first drive connection 8, here the adjustable element-side drive connection 8, and a second drive connection 9, here the body-side drive connection 9, for coupling it to the motor vehicle 3, wherein the drive 1 has a drive train 4 with two drive portions that can in particular be linearly adjusted with respect to one another along a geometric drive axis 14 between a retracted position and an extended position and that comprise a plurality of train components that are coupled to one another so as to transmit force or torque in order to transmit a force introduced into the drive connections 8, 9, wherein each of the drive portions is assigned to one of the drive connections 8, 9, wherein the drive 1 has a feed gear 7 for carrying out in particular linear drive movements along the geometric drive axis 14, wherein one of the two drive portions has a drive unit 15 comprising a drive motor 5 downstream of which the feed gear 7 is arranged, wherein the drive motor 5 has a motor shaft 6 that has a geometric motor shaft axis 16 and transmits a torque generated by the drive motor 5, and a bearing arrangement 17 for mounting the motor shaft 6, comprising at least one motor shaft bearing 11, in particular a sliding bearing, that has a geometric bearing center axis 18 and is configured to radially support the motor shaft 6.

The bearing center axis 18 is defined as the axis that defines the radial center of the motor shaft bearing 11 in the unloaded and also in the loaded state. Here and preferably, the bearing arrangement 17 comprises a plurality of motor shaft bearings 11, in particular plain bearings, that have a common geometric bearing center axis 18 and are configured to radially support the motor shaft 6.

It is essential that the drive 1 has a radial force introduction unit 19 which is configured to act radially on the rotating motor shaft 6 in the assembled state so that the motor shaft 6 rests against one side of the motor shaft bearing 11 in a defined position.

In the present context, applying a radial force to the motor shaft 6 means that a force is introduced into the motor shaft 6 with a force direction oriented radially to the geometric motor shaft axis 16.

The side of the motor shaft bearing 11, against which the motor shaft 6 rests in a defined position as proposed, is defined by its position relative to a stationary element of the drive 1 and is therefore always directed toward the same point in the drive 1.

The radial force introduction unit 19 exerts a targeted radial force on the rotating motor shaft 6. This force forces the motor shaft 6 in a specific direction within the corresponding motor shaft bearing 11 within the bearing clearance (here a bearing clearance of, for example, 0.01 mm to 0.1 mm, preferably 0.01 mm to 0.05 mm), whereby the motor shaft 6 is positioned on a radial side of the motor shaft bearing 11 and rests against it in a defined position. The radial force introduction unit 19 thus forces the motor shaft 6 into a position that deviates from the geometric bearing center axis 18, meaning that the geometric motor shaft axis 16 and the geometric bearing center axis 18 are not coaxial with one another. Instead, the geometric motor shaft axis 16 is in particular curved or inclined with respect to the geometric bearing center axis 18. In particular, the two geometric axes 16, 18 intersect at at least one intersection point 20.

The targeted load on one side clamps the motor shaft 6 in the motor shaft bearing 11, or, in the case of a plurality of motor shaft bearings 11, in one or at least two of the motor shaft bearings 11, causing the motor shaft 6 to assume a defined position in the corresponding motor shaft bearing 11. This in turn can prevent the rotating motor shaft 6 from oscillating freely and suppress corresponding modulating background noise.

In this context, the terms “axial” and “radial” always refer to the geometric drive axis 14. Accordingly, the axial direction is the direction in which the geometric drive axis 14 extends.

Furthermore, it is provided here and it is preferable that the radial force introduction unit 19 has a force application means 21. The force application means 21 radially deflects the motor shaft 6 and/or a drive part 22 that is coupled to the motor shaft 6 for transmitting torque, in particular for conjoint rotation and preferably to be axially fixed, with respect to an unloaded state, thus pushing the motor shaft 6 and/or the drive part 22 in a certain radial direction.

In order to achieve the proposed function, i.e., so that the rotating motor shaft 6 is pushed radially to one side into the motor shaft bearing 11 in the assembled state and rests against one bearing side of the motor shaft bearing 11 in a defined position, the force application means 21 acts on the motor shaft 6 either directly or via said drive part 22 coupled to the motor shaft 6 for transmitting torque. The drive part 22 is in particular a gear component, as will be explained further below.

The force application means 21 is in this case and preferably formed by an independent, i.e., separate, component. However, in accordance with another embodiment not shown here, it is alternatively also conceivable that the force application means 21 is formed by a portion of a component that is fixed for conjoint rotation with, and in particular axially fixed relative to, the drive motor 5 or of a component that is rotatable, and in particular axially fixed, relative to the drive motor 5.

“Independent” or “separate” component means a component of the drive 1 that is intended for the proposed function, specifically applying a radial force to or radially deflecting the rotating motor shaft 6 to one side, and which itself in particular does not provide a torque-transmitting function for the purpose of generating the linear drive movements, preferably provides no further functions in the drive 1 whatsoever, as will be explained in more detail below. In contrast, “component portion” means a portion of a component which, in addition to the proposed function of applying radial force to one side of or radially deflecting the rotating motor shaft 6, also provides at least one further function in the drive 1, for example a housing function, thus a protective function, and/or a function as a gear component that is fixed for conjoint rotation with the drive motor 5.

Here and preferably, the radial force introduction unit 19 or the force application means 21 radially acts on the motor shaft 6 outside the motor housing 10 of the drive motor 5.

It can also be provided that the radial force introduction unit 19 or the force application means 21 radially acts on the motor shaft 6 within the motor housing 10 of the drive motor 5.

Furthermore, it is provided in this case and preferably that the radial force introduction unit 19 or the force application means 21 radially acts on the motor shaft 6 on the axial side of the drive motor 5 facing the feed gear 7.

The axial side of the drive motor 5 facing the feed gear 7 is the side on which the torque generated by the drive motor 5 is passed from the drive motor 5 to the feed gear 7. On this side, the motor shaft 6 is particularly susceptible to vibration.

However, it can also be provided that the radial force introduction unit 19 or the force application means 21 radially acts on the motor shaft 6 on the side of the drive motor 5 facing away from the feed gear 7.

The side of the drive motor 5 facing away from the feed gear 7 is the axial side (rear of the drive motor) facing the nearest drive connection 8, 9. On this axial side, the drive motor 5 or the motor housing 10 usually has, as is the case here, an axial end cap 23 and/or carries a commutator (inside the motor housing 10) and/or a rotary encoder, for example a Hall sensor (outside the motor housing 10).

In the following, particularly preferred embodiments of the force application means 21 are to be explained.

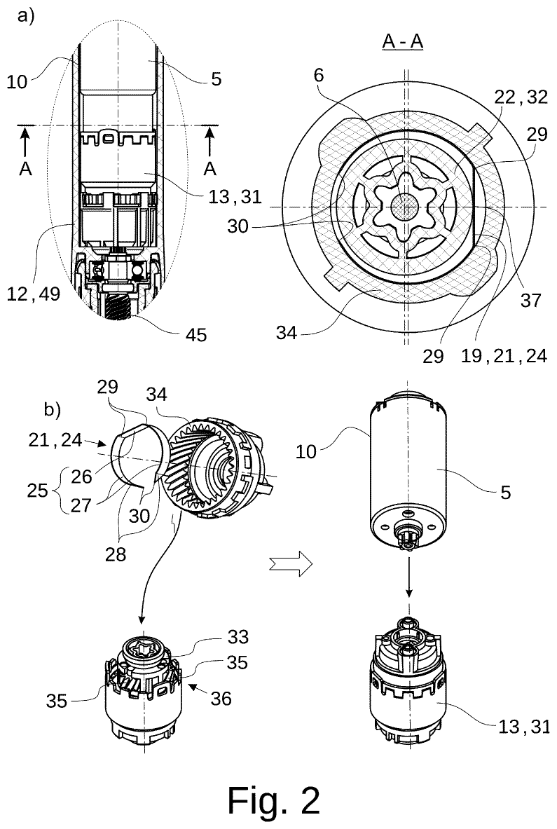

In accordance with FIG. 2, it is provided in this case, and it is preferable that the radial force introduction unit 19 has a preferably elastic clip 24, made of metal and/or spring steel sheet 24, as the force application means 21.

In this context, “elastic” means that the clip 24 deforms elastically during assembly and can return to its original state, which it held before assembly, after disassembly.

In the assembled state, the clip 24 extends around the motor shaft 6 and/or the drive part 22 which is coupled to the motor shaft 6 to transmit torque,

The clip 24, in particular the spring steel sheet 24, has a thickness (dimension in the radial direction) of 0.1 mm to 1 mm, preferably of 0.1 mm to 0.5 mm, more preferably of 0.1 mm to 0.2 mm, over its entire extent extending around the geometric bearing center axis 18.

Furthermore, the clip 24 has an inner contour 25 that extends around the drive part 22 in the assembled state, which contour is arranged radially closer to the geometric bearing center axis 18 in a first contour portion 26 than in at least one second contour portion 27.

The first contour portion 26 therefore points radially further inward than the at least one second contour portion 27, in this case the two second contour portions 27, or the rest of the inner contour 25. The second contour portion(s) 27 in particular form, as FIG. 2 shows, the largest part of the inner contour 25, with the exception here of at least one end portion 28 of the clip 24 comprising a radially outward-or inward-facing edge, which will be described below.

Due to the special course of the inner contour 25 of the clip 24, the clip 24 radially acts on the rotating motor shaft 6 in the assembled state, here and preferably indirectly, so that the motor shaft 6 rests in a defined position against one side of the motor shaft bearing 11, which will be described in more detail below.

The first contour portion 26 of the inner contour 25 has in this case and preferably a tangential, i.e., straight, course with respect to the geometric bearing center axis 18 in the assembled state, but can also have a curved course, in particular a radially inwardly curved course. Additionally or alternatively, in the assembled state, the at least one second contour portion 27 of the inner contour 25 in this case and preferably has a radially outwardly curved, in particular circular arc-shaped, course with respect to the geometric bearing center axis 18.

The first contour portion 26 is in this case and preferably delimited by a bent edge 29 with respect to the second contour portion(s) 27, which are in this case each adjacent thereto.

Furthermore, it is provided in this case and preferably that the clip 24, in the assembled state, has a radially outward-facing end-side edge 30 or a radially inward-facing end-side edge, in particular in one or two circumferential end portions 28, by means of which the clip 24 is secured against rotation in the assembled state. This will be explained in more detail below.

In the drive 1 in FIGS. 1 to 3, the drive unit 15 has a reduction gear 13 downstream of the drive motor 5, downstream of which the feed gear 7 is arranged. In accordance with the previous definition, the reduction gear 13 is arranged on the axial side of the drive motor 5 facing the feed gear 7.

In this case and preferably, the drive part 22, which is coupled to the motor shaft 6 to transmit torque and which the force application means 21 applies radial force to or radially deflects, is a gear component of the reduction gear 13.

The rotating motor shaft 6 is subjected to radial force in the assembled state by the clip 24 or the special course of the inner contour 25 thereof via the drive part 22, in particular the gear component, so that the motor shaft 6 rests in a defined position against one side of the motor shaft bearing 11. The clip 24 thus introduces a radial force into the drive part 22 or the gear component, which sits rigidly on the motor shaft 6 with respect to the radial direction and is consequently subjected to radial force or is radially deflected by the clip 24 or the radial force together with the motor shaft 6.

Here and preferably, the reduction gear 13 has a planetary gear 31, which has a rotatable sun gear 32 and, coaxially therewith, a rotatable planet carrier 33 and a fixed or fixable ring gear 34. The planet carrier 33 carries at least one rotatable planetary gear 35, which is in axially parallel engagement with the corresponding sun gear 32 on the one hand and the corresponding ring gear 34 on the other.

“Fixed” means here that the ring gear 34 is fixed for conjoint rotation with the drive motor 5 and/or drive housing 12.

The drive part 22, which is coupled to the motor shaft 6 so as to transmit torque and is subjected to radial force or is radially deflected by the force application means 21, is preferably, as shown in FIG. 2, the sun gear 32 of the planetary gear 31.

It is also possible to provide a plurality of, here two, gear stages 36, which are connected in series and each formed by a planetary gear 31. The sun gear 32 in question is then the sun gear 32 of the first gear stage 36.

By means of the clip 24 or the special course of the inner contour 25 thereof, the rotating motor shaft 6 is thus subjected to radial force via said sun gear 32 in the assembled state so that the motor shaft 6 rests in a defined position against one side of the motor shaft bearing 11. The clip 24, in particular the first contour portion 26, accordingly introduces a radial force into the sun gear 32, which rigidly sits on the motor shaft 6 with respect to the radial direction and is consequently subjected to a radial force or radial deflection by the clip 24 or the radial force together with the motor shaft 6.

Furthermore, it is provided here and is preferable that the clip 24 is arranged, in particular clamped, radially between the sun gear 32 and the ring gear 34 in the assembled state. “Clamped” means here that the clip 24 is under permanent radial preload in the assembled state. The clip 24 is supported on the radial inside of the ring gear 34 and deflects the sun gear 32 radially due to the existing preload, whereby the motor shaft 6, to which the sun gear 32 is coupled, is subjected to a radial force or is radially deflected to the same extent.

The clip 24 is in this case and preferably secured against rotation relative to the ring gear 34. The sun gear 32 accordingly rotates relative to the clip 24 when the motor shaft 6 rotates. The anti-rotation mechanism is formed in particular by frictional, alternatively or additionally also interlocking, engagement between the radially outward-facing end-side edges of the clip 24 and the ring gear 34. When, as is the case here, the clip 24 is secured against rotation relative to the ring gear 34, the sun gear 32 preferably and in this case only comes into contact with the first contour portion 26, in particular its center, thus touching the clip 24 only by means of a single contact region 37, this in particular being substantially linear. The sun gear 32 then slides along the clip 24 by said region. In accordance with another embodiment not shown here, it is alternatively also conceivable that the clip 24 is secured against rotation relative to the sun gear 32 and rotates with the sun gear 32 relative to the ring gear 34 when the motor shaft 6 rotates. The anti-rotation mechanism is then formed in particular by frictional, alternatively or additionally also interlocking, engagement between radially inward-facing end-side edges of the clip 24 and the sun gear 32.

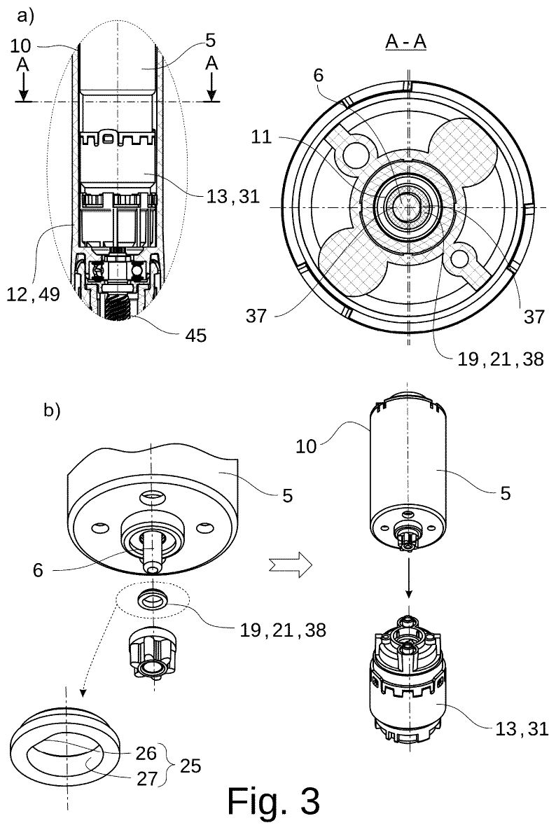

Another variant of a force application means 21 is also shown in FIG. 3.

It is preferably provided here that the radial force introduction unit 19 has a preferably rigid, ring-shaped additional part 38, in particular made of metal and/or casting material, as the force application means 21.

In this context, “rigid” means that the ring-shaped additional part 38 does not elastically deform during assembly, or in any case not to a significant extent.

“Annular” means here that the additional part 38 is mostly or completely closed around its circumference and in particular has a predominantly circular arc-shaped inner contour 25, preferably also an at least predominantly circular arc-shaped outer contour 39.

The ring-shaped additional part 38 extends around the motor shaft 6 in the assembled state.

Preferably, the ring-shaped additional part 38 has an inner contour 25 that extends around the motor shaft 6 in the assembled state and is arranged radially closer to the geometric bearing center axis 18 in at least one first contour portion 26 than in at least one second contour portion 27. The at least one first contour portion 26, in this case the only first contour portion 26, therefore it also points radially further inward than the at least one second contour portion 27, in this case the only second contour portion 27, or the rest of the inner contour 25. The second contour portion(s) 27 in particular form, as shown in FIG. 3, the largest part of the inner contour 25.

Due to the special course of the inner contour 25 of the ring-shaped additional part 38, the rotating motor shaft 6 is subjected to radial force by the ring-shaped additional part 38, in this case directly, in the assembled state so that the motor shaft 6 rests against one side of the motor shaft bearing 11 in a defined position, as will be described in more detail below.

The first contour portion 26 of the inner contour 25 has in this case and preferably a tangential, i.e., straight, course with respect to the geometric bearing center axis 18 in the assembled state, but can also have a curved course, in particular a radially inwardly curved course. Additionally or alternatively, in the assembled state, the at least one second contour portion 27 of the inner contour 25 has a radially outwardly curved, in particular circular arc-shaped, course with respect to the geometric bearing center axis 18.

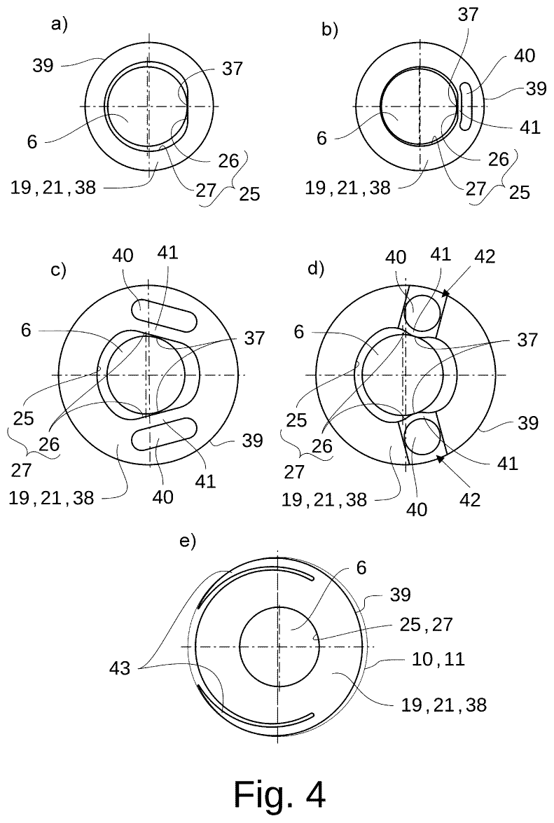

In accordance with FIG. 3, the first contour portion 26 is formed here and preferably by an inner flattened portion, while the second contour portion 27 is circular arc-shaped. The motor shaft 6 in this case and preferably only comes into contact with the first contour portion 26, in particular in the center thereof, and the opposite portion of the second contour portion 27, thus touching the ring-shaped additional part 38 only by means of two opposite contact regions 37, these in particular being substantially linear. The motor shaft 6 slides in the ring-shaped additional part 38 by means of these regions. In principle, it would also be conceivable, as shown by way of example in FIG. 4a), that the motor shaft 6 only comes into contact with the first contour portion 26, in particular in the center thereof, thus touching the ring-shaped additional part 38 only by means of a contact region 37, which is in particular substantially linear.

The force application means 21 in FIG. 3 described above by way of example is shown again in the assembled state together with the motor shaft 6 in FIG. 4a). Further variants of the force application means 21 are shown in FIG. 4b) to e) and will be described below.

The variants in FIG. 4a) to d) illustrate that, in principle, the inner contour 25 can have not just a single first contour portion 26 (FIG. 4a) and b)), but can also have at least two, or exactly two, first contour portions 26 (FIG. 4c) and d)).

In the latter case, the first contour portions 26 are not arranged diametrically opposite one another but are offset relative to the center of the force application means 21 in order to apply a radial force in one direction to the rotating motor shaft 6 in the assembled state, as described.

Furthermore, in accordance with the embodiments in FIG. 4b) to d), it is provided here and is preferable that the ring-shaped additional part 38 has an outer contour 39 extending around the motor shaft 6 in the assembled state, and that at least one, or exactly one, cavity 40, in particular a hole, is provided radially between the outer contour 39 and the at least one first contour portion 26 of the inner contour 25. The hole is preferably a round hole (FIG. 4d)) or a slot (FIG. 4b) and c)). In principle, however, the region radially between the outer contour 39 and the at least one first contour portion 26 of the inner contour 25 can also be free of cavities 40, as per FIGS. 3 and 4a).

In the case of a cavity 40, it is preferable that a web 41 is formed radially between the at least one first contour portion 26 of the inner contour 25 and the cavity 40, against which the motor shaft 6 rests in the assembled state and which, as part of the radial force introduction unit 19, radially acts on the rotating motor shaft 6 in the assembled state so that the motor shaft 6 rests in a defined position against one side of the motor shaft bearing 11. Preferably, the web 41 is more elastic than the material of the motor shaft 6 and/or dampens vibrations from the motor shaft 6 during operation. In this respect, the web 41 forms a damping element. The technical design comprising one, two or more such damping elements allows the force applied by the motor shaft 6 to the motor shaft bearing 11 to be precisely adjusted. This radial force is adjusted to provide the contact of the motor shaft 6 and thus the formation of the lubricating film. Conversely, the selected radial force is so low that additional drag torque and bearing wear are kept to a minimum. Alternatively, a defined increased drag torque can be targetedly introduced to generate advantages in terms of system application.

Furthermore, it is provided here and is preferable that, as shown by way of example in FIG. 4d), the ring-shaped additional part 38 has at least one circumferential portion 42 with reduced axial thickness. Here and preferably, the cavity 40 and/or the web 41 is/are arranged in each circumferential portion 42. By reducing the thickness in the region of each cavity 40 and/or web 41, improved elasticity and thus an improved damping effect can be achieved.

Another variant is shown in FIG. 4e). In this variant, the receptacle for the shaft defined by the inner contour 25 is preferably circular, unlike in the other embodiments, and in particular substantially corresponds to the cross section of the motor shaft 6 so that the motor shaft 6 is mounted with clearance in the receptacle. Here, it is therefore preferably the case that the inner contour 25 of the ring-shaped additional part 38 does not have the above first contour portion 26 in which the inner contour 25 is arranged radially closer to the geometric bearing center axis 18 than in at least one second contour portion 27. Instead, only a second contour portion 27 is provided here, which forms the entire inner contour 25. Alternatively, as described above, it is however also conceivable to also form the inner contour 25 with a first contour portion 26 as mentioned above.

In the variant in accordance with FIG. 4e), it is now preferably the case that the ring-shaped additional part 38 has one or more, in particular two, spring tongues 43 extending over part of the circumference of the additional part 38. In the assembled state, the spring tongues 43 are supported radially on one side on a component fixed to the housing of the drive motor 5, in particular the motor shaft bearing 11 or the motor housing 10.

Here and preferably, as part of the radial force introduction unit 19, each spring tongue 43 causes the ring-shaped additional part 38 to be furthermore radially offset by means of the radial one-sided support and thereby acts radially on the rotating motor shaft 6 in the assembled state so that the motor shaft 6 rests against one side of the motor shaft bearing 11 in a defined position, as described. Here and preferably, each spring tongue 43 is more elastic than the material of the component fixed to the housing and/or dampens vibrations from the motor shaft 6 during operation.

As shown in FIG. 3, the ring-shaped additional part 38 is in this case and preferably arranged radially between the motor shaft 6 and the motor shaft bearing 11 or one of the motor shaft bearings radially supporting the motor shaft 6 in the assembled state. The motor shaft bearing 11 thus forms a counter-bearing for the ring-shaped additional part 38, i.e., the ring-shaped additional part 38 is supported on the radial inside of the motor shaft bearing 11. In principle, another component fixed to the housing of the drive motor 5, for example the motor housing 10, could also serve as a counter-bearing, against the radial inside of which the ring-shaped additional part 38 is supported in the assembled state.

The ring-shaped additional part 38, or rather the special course of the inner contour 25 thereof, directly applies radial force to the rotating motor shaft 6 in the assembled state so that the motor shaft 6 rests in a defined position against one side of the motor shaft bearing 11. The ring-shaped additional part 38, in particular the first contour portion 26, thus introduces a radial force into the motor shaft 6 and deflects it radially or applies force thereto in the radial direction.

Here and preferably, the ring-shaped additional part 38 is also secured against rotation in the motor shaft bearing 11, in particular by a form fit, force fit or integral bond, in this case by a press fit.

In the embodiments shown here and which are preferred in this respect, it is generally the case that the geometric motor shaft axis 16 is tilted or curved relative to the geometric bearing center axis 18 when the radial force introduction unit 19 or the force application means 21 are applying radial force to the motor shaft 6. These two alternatives are represented schematically by dashed lines in FIG. 1c).

As already previously indicated, the proposed drive 1 shown by way of example in each of FIGS. 1 to 3 is a spindle drive. Accordingly, it is provided here and is preferable that the feed gear 7 is a spindle-spindle nut gear 44 comprising a spindle 45 and a spindle nut 46 that meshes therewith, and that one of the two drive portions comprises the spindle 45 and the other of the two drive portions comprises the spindle nut 46. Here, the spindle 45 is axially fixed relative to the first drive connection 8, in this case the drive connection 8 on the adjustable element side, and the spindle nut 46 is axially fixed relative to the second drive connection 9, in this case the drive connection 9 on the body side, via a spindle guide tube 47.

Furthermore, it is provided here and it is preferable that the drive 1 has a drive housing 12 with a housing inner tube 48 and a housing outer tube 49. The housing inner tube 48 extends telescopically in the housing outer tube 49. In this case, the housing inner tube 48 is connected to one of the two drive portions and the housing outer tube 49 is connected to the other of the two drive portions to be axially fixed. Here and preferably, the radial force introduction unit 19 and/or the force application means 21 is/are radially surrounded by the drive housing 12, in particular the housing outer tube 49. Additionally or alternatively, the radial force introduction unit 19 and/or the force application means 21 is/are arranged axially outside the motor housing 10 of the drive motor 5 as is the case here.

Here and preferably, a drive spring arrangement 50 comprising at least one helical spring 51 is also arranged coaxially with the geometric drive axis 14. The drive spring arrangement 50 is arranged with the at least one helical spring 51 inside the drive housing 12, in particular inside the housing inner tube 48 and/or housing outer tube 49. The drive spring arrangement 50 preloads the two drive portions against one another, in particular into the extended position. Furthermore, it is provided here, and it is preferable that a spring guide tube 52 extends inside or outside the at least one helical spring 51 to guide the at least one helical spring 51, wherein the spring guide tube 52 is preferably axially fixed at one of its ends to one of the two drive portions, in particular to the drive portion which comprises the drive unit 15.

What is claimed is:

1. A drive, in particular a spindle drive, for adjusting an adjustable element, in particular
a flap, of a motor vehicle;
the drive having a first drive connection and a second drive connection for coupling it to the motor vehicle;
the drive comprising a drive train with two drive portions, which can be adjusted relative to one another, in particular linearly, along a geometric drive axis between a retracted position and an extended position and which comprise a plurality of train components which are coupled to one another to transmit force or torque so as to transmit a force introduced into the drive connections, each of the drive portions being assigned to one of the drive connections;
the drive having a feed gear for carrying out in particular linear drive movements along the geometric drive axis;
one of the two drive portions having a drive unit with a drive motor, downstream of which the feed gear is arranged; and,
the drive motor having a motor shaft that has a geometric motor shaft axis and transmits a torque generated by the drive motor, and a bearing arrangement with at least one motor shaft bearing, which comprises a geometric bearing center axis and is configured to radially support the motor shaft, wherein the drive has a radial force introduction unit configured to act radially on the rotating motor shaft in the assembled state so that the motor shaft rests against one side of the motor shaft bearing in a defined position.

2. The drive according to claim 1, wherein the radial force introduction unit has a force application means and in that the force application means radially deflects the motor shaft or a drive part that is coupled to the motor shaft for transmitting torque, in particular for conjoint rotation and preferably so as to be axially fixed.

3. The drive according to claim 2, wherein the force application means is formed by a separate component, or in that the force application means is formed by a component portion that is fixed for conjoint rotation with, and in particular axially fixed relative to, the drive motor or of a component that is rotatable, and in particular axially fixed, relative to the drive motor.

4. The drive according to claim 1, wherein the radial force introduction unit or the force application means radially acts on the motor shaft outside or inside a motor housing of the drive motor.

5. The drive according to claim 4, wherein the radial force introduction unit or the force application means radially acts on the motor shaft on the axial side of the drive motor that faces the feed gear, or in that the radial force introduction unit or the force application means radially acts on the motor shaft on the side of the drive motor facing away from the feed gear.

6. The drive according to claim 1, wherein the radial force introduction unit has a preferably elastic clip, in particular made of metal and/or spring steel sheet, as the force application means, wherein in the assembled state, the clip extends around the motor shaft and/or the drive part coupled to the motor shaft so as to transmit torque, and in that the clip has an inner contour that extends around the drive part in the assembled state, which contour is arranged radially closer to the geometric bearing center axis in a first contour portion than in at least one second contour portion, preferably in that the first contour portion of the inner contour has a tangential course or an in particular radially inwardly curved course with respect to the geometric bearing center axis in the assembled state, and/or in that the at least one second contour portion of the inner contour has a course, in particular a circular arc-shaped course, that is radially outwardly curved with respect to the geometric bearing center axis in the assembled state.

7. The drive according to claim 6, wherein in the assembled state, the clip has a radially outward-facing end-side edge or a radially inward-facing end-side edge in particular in one or two circumferential end portions, by means of which the clip is secured against rotation in the assembled state.

8. The drive according to claim 1, wherein the drive unit has a reduction gear downstream of the drive motor, downstream of which gear the feed gear is arranged, preferably in that the drive part that is coupled to the motor shaft to transmit torque and is radially deflected by the force application means is a gear component of the reduction gear.

9. The drive according to claim 8, wherein the reduction gear has a planetary gear which has a rotatable sun gear and a rotatable planet carrier coaxially thereto and a fixed or fixable ring gear, which planet carrier carries at least one rotatable planetary gear which is in axially parallel engagement with the corresponding sun gear on the one hand and the corresponding ring gear on the other hand, preferably in that the drive part that is coupled to the motor shaft to transmit torque and is radially deflected by the force application means is the sun gear of the planetary gear.

10. The drive according to claim 9, wherein the clip is arranged, in particular clamped, radially between the sun gear and the ring gear in the assembled state, preferably in that the clip is secured for conjoint rotation with the ring gear, in particular by the radially outward-facing end-side edges, or in that the clip is secured against rotation relative to the sun gear, in particular by the radially inward-facing end-side edges.

11. The drive according to claim 1, wherein the radial force introduction unit has a preferably rigid, ring-shaped additional part, in particular made of metal and/or casting material as the force application means, and in that the ring-shaped additional part extends around the motor shaft in the assembled state, preferably in that the ring-shaped additional part has an inner contour that extends around the motor shaft in the assembled state and is arranged radially closer to the geometric bearing center axis in at least one first contour portion than in at least one second contour portion, preferably in that the at least one first contour portion of the inner contour has, in the assembled state, a tangential course or an in particular radially inwardly curved course with respect to the geometric bearing center axis, and/or in that the at least one second contour portion of the inner contour has a radially outwardly curved, in particular circular arc-shaped, course with respect to the geometric bearing center axis in the assembled state.

12. The drive according to claim 11, wherein the inner contour has at least or exactly two first contour portions and in that the first contour portions are not diametrically opposite one another.

13. The drive according to claim 11, wherein the ring-shaped additional part has an outer contour extending around the motor shaft in the assembled state, and in that at least one or exactly one cavity, in particular a hole, preferably a round hole or a slot, is provided radially between the outer contour and the at least one first contour portion of the inner contour, preferably in that a web is formed radially between the at least one first contour portion of the inner contour and the cavity, against which the motor shaft rests in the assembled state and which, as part of the radial force introduction unit, radially acts on the rotating motor shaft in the assembled state so that the motor shaft rests in a defined position against one side of the motor shaft bearing, preferably in that the web is more elastic than the material of the motor shaft and/or dampens vibrations from the motor shaft during operation.

14. The drive according to claim 11, wherein the ring-shaped additional part has at least one circumferential portion of reduced axial thickness, preferably in that the cavity and/or the web is/are arranged in each circumferential portion.

15. The drive according to claim 11, wherein the ring-shaped additional part has one or more, in particular two, spring tongues extending over part of the circumference of the additional part and which, in the assembled state, are radially supported against a component fixed to the housing of the drive motor, in particular the motor shaft bearing or the motor housing, on one side, preferably in that each spring tongue, as part of the radial force introduction unit, furthermore causes the ring-shaped additional part to be radially offset by means of the radial one-sided support and thereby acts radially on the rotating motor shaft in the assembled state so that the motor shaft rests against one side of the motor shaft bearing in a defined position, preferably in that each spring tongue is more elastic than the material of the component fixed to the housing and/or dampens vibrations from the motor shaft during operation.

16. The drive according to claim 11, wherein in the assembled state, the ring-shaped additional part is arranged radially between the motor shaft and the motor shaft bearing or one of the motor shaft bearings radially supporting the motor shaft, preferably in that the ring-shaped additional part is secured against rotation in the motor shaft bearing, in particular by a form fit, force fit or integral bond.

17. The drive according to claim 11, wherein the geometric motor shaft axis is tilted or curved relative to the geometric bearing center axis when the radial force introduction unit or the force application means acts radially on the motor shaft.

18. The drive according to claim 1, wherein the feed gear is a spindle-spindle nut gear with a spindle and a spindle nut meshing therewith, and in that one of the two drive portions comprises the spindle and the other of the two drive portions comprises the spindle nut.

19. The drive according to claim 1, wherein the drive has a drive housing with a housing inner tube and a housing outer tube, in that the housing inner tube extends telescopically in the housing outer tube and in that the housing inner tube is axially fixedly connected to one of the two drive portions and the housing outer tube to the other of the two drive portions, preferably in that the radial force introduction unit and/or the force application means is/are radially surrounded by the drive housing, in particular the housing outer tube, and/or is/are arranged axially outside the motor housing of the drive motor.

20. The drive according to claim 2, wherein the radial force introduction unit or the force application means radially acts on the motor shaft outside or inside a motor housing of the drive motor.
